(19) United States
(12) Patent Application Publication
(10) Pub. No.: US 2020/0298039 A1
(43) Pub. Date: Sep. 24, 2020

(54) METHODS AND SYSTEMS FOR MANAGEMENT OF CORROSION IN BUILDING PIPE CIRCULATION SYSTEMS

(71) Applicant: Engineered Corrosion Solutions, LLC, St. Louis, MO (US)

(72) Inventor: Jeffrey T. Kochelek, Creve Coeur, MO (US)

(21) Appl. No.: 16/789,380

(22) Filed: Feb. 12, 2020

Related U.S. Application Data
(63) Continuation-in-part of application No. 16/174,561, filed on Oct. 30, 2018.
Application No. 16/174,561 is a division of application No. 14/341,398, filed on Jul. 25, 2014, now Pat. No. 10,188,885.
Application No. 14/341,398 is a division of application No. 13/048,596, filed on Mar. 15, 2011, now Pat. No. 9,526,933.
Application No. 13/048,596 is a continuation-in-part of application No. PCT/US2009/056000, filed on Sep. 4, 2009.
Application No. PCT/US2009/056000 is a continuation of application No. 12/210,555, filed on Sep. 15, 2008, now Pat. No. 9,144,700.
Application No. 12/210,555 is a continuation-in-part of application No. 16/259,974, filed on Jan. 28, 2019.
Application No. 16/259,974 is a continuation of application No. 14/341,398, filed on Jul. 25, 2014, now Pat. No. 10,188,885.
Application No. 14/341,398 is a division of application No. 13/048,596, filed on Mar. 15, 2011, now Pat. No. 9,526,933.
Application No. 13/048,596 is a continuation-in-part of application No. PCT/US09/56000, filed on Sep. 4, 2009.
Application No. PCT/US09/56000 is a continuation of application No. 12/210,555, filed on Sep. 15, 2008, now Pat. No. 9,144,700.
(60) Provisional application No. 62/804,433, filed on Feb. 12, 2019.
(60) Provisional application No. 61/357,297, filed on Jun. 22, 2010.
(60) Provisional application No. 61/357,297, filed on Jun. 22, 2010.

(51) Int. Cl. A62C 35/68; A62C 35/62; A62C 35/60; A62C 35/64

(52) U.S. Cl. CPC A62C 35/68; A62C 35/62; Y10T 137/8634; A62C 35/645; Y10T 137/3115; A62C 35/60

(57) ABSTRACT

A building pipe network system and method of operating a building pipe network inerting system includes providing an inert gas source, at least one of a closed loop water chiller system and a fire protection system. The closed loop water chiller system has a compressor, a condenser, an evaporator, a first pipe network, and a first vent in fluid connection with the first pipe network. The fire protection system has a source of pressurized water, a second pipe network fluidly connected with the source of pressurized water, a sprinkler fluidly connected with the second pipe network, and a second vent in fluid connection with the second pipe network. There is also a first fluid connection between the first pipe network and the nitrogen source, and a second fluid connection between the second pipe network and the nitrogen source. An inert gas source, such as a nitrogen gas source, is connected to at least one of, and preferably all, the present pipe networks. Inert gas is supplied from the inert gas source to the pipe network. Water is supplied to the pipe network thereby substantially filling the pipe network with water and compressing the inert gas in the pipe network.

### CROSS REFERENCE TO RELATED APPLICATIONS

This application is claims the benefit and priority of co-pending U.S. Provisional Patent Application Ser. No. 62/804,433 filed Feb. 12, 2019, the entire disclosure of which is hereby incorporated herein by reference. The application further claims the benefit and priority of co-pending U.S. patent applications Ser. No. 16/174,561 filed Oct. 30, 2018 and Ser. No. 16/259,974 filed Jan. 28, 2109, which are, respectively a divisional and a continuation of U.S. patent application Ser. No. 14/341,398, now U.S. Pat. No. 10,188,885, filed Jul. 25, 2014, which is a divisional of U.S. patent application Ser. No. 13/048,596, now U.S. Pat. No. 9,526,933, filed Mar. 15, 2011, which claims the benefit of U.S. Provisional Application No. 61/357,297 filed Jun. 22, 2010, and which is a continuation-in-part of International Patent Application No. PCT/US09/56000 filed Sep. 4, 2009, which claims the benefit and priority of U.S. patent application Ser. No. 12/210,555, now U.S. Pat. No. 9,144,700, filed Sep. 15, 2008. The entire disclosures of the above applications are incorporated herein by reference.

### BACKGROUND OF THE DISCLOSURE

The present disclosure is directed to anti-corrosion protection in pipe networks of buildings and other structures.

Many buildings and building complexes, such as industrial plants, hospitals, commercial office buildings and the like, incorporate systems of various types that currently make use of or could benefit from the use of a source of pressurized nitrogen or other inert gases for various processes or maintenance tasks. For example, essentially all large scale structures are required to incorporate fire protection systems, which can significantly benefit from nitrogen inerting such as is described in U.S. Pat. No. 9,144,700, issued Sep. 29, 2015, U.S. Pat. No. 9,186,533, and U.S. Published Patent Application 2015/0014000, published Jan. 15, 2015, now U.S. Pat. No. 10,188,885, the entire disclosures of each of which are hereby incorporated by reference. Other buildings utilize closed loop water chiller systems to provide cooling for HVAC and other building processes, which can also benefit from being inerted with nitrogen.

A chiller system removes heat from a liquid via a vapor-compression or absorption refrigeration cycle. This liquid can then be circulated through a heat exchanger to cool equipment, or another process stream (such as air or process water). As a necessary by product, refrigeration creates waste heat that must be exhausted.

The basic components of most water chiller systems include a compressor that converts energy into compressed refrigerant. Compressed refrigerant is transferred to a condenser that transfers heat from the refrigerant to a water coolant. The compressed refrigerant changes state from a gas to a liquid in the condenser and then travels to an evaporator where it allowed to expand in the evaporator. The expansion of the high pressure liquid refrigeration reduces the temperature of the evaporator. The liquid to be cooled is pumped through the evaporator heat exchanger and heat is transferred to the refrigerant. The low pressure vapor is carried back to the compressor and the cycle begins again for the refrigerant. The coolant flows from the evaporator heat exchanger to the load where the heat is transferred to the coolant in the load heat exchanger and then returns back to the evaporator to repeat the cycle.

Chiller systems may be placed into service in large scale facilities to provide conditioned air for distribution in one or more portions of the facility. Chiller systems are also utilized in industrial process applications and integrated into process or laboratory equipment to cool products or machinery. They are widely used in connection with molding, metal working, welding, die-casting, machine tooling, chemical processing, and other industries, as well as to provide cooling for high heat generating specialized equipment. Water-based chiller units are a common choice in industrial process applications.

In building HVAC systems, chiller systems operate by distributing chilled water heat exchanging structures, which cool air within the space associated with the heat exchanger by heat transfer. The heated water is then recirculated to the chiller to be recooled.

In commercial and industrial applications, water chiller systems typically include a separate condenser water loop and are connected to exterior cooling towers to improve thermodynamic performance and may provide increased efficiency versus air-cooled and evaporatively cooled chiller systems. These systems are typically installed as closed-loop systems, including the chiller unit, condenser, and pump station with recirculating pump, expansion valve, no-flow shutdown, and internal cold water control. An internal tank helps maintain cold water temperature and prevents temperature spikes from occurring. Closed-loop industrial water chillers recirculate clean water at a constant temperature and pressure to increase the stability and reproducibility of water-cooled machines and instruments.

Notably, water chiller systems utilize carbon steel—also referenced as black steel—piping or similar ferrous or cuprous materials. In closed loop chiller systems, resulting in oxygen being trapped within the pipe network. Trapped oxygen reacts with the steel piping to cause corrosion thereby causing multiple negative results, including pitting pipe surfaces and corrosion by product debris (iron oxide hematite) that is then trapped within the closed system. Because of the typically highly complex piping arrangement in these systems, it is extremely difficult to simply vent trapped oxygen from the pipe networks.

As a further exacerbation of the oxygen-based corrosion issue in water chiller systems, the pipe networks are regularly drained and refilled for maintenance and other purposes. While oxygen that is trapped in the system while the system is closed during operation is slowly consumed by the corrosion reaction, each time the pipe networks are drained. Additionally, corrosion by product debris accumulating hear heat exchanger surfaces can interfere with heat transfer at these locations because of the insulating effect of the accumulated debris. These resulting “hot spots” further accelerate corrosion and eventually failure of the piping and/or heat exchanger components at these spots.

More particularly, deterioration and corrosion of piping in closed-loop water chiller systems can involve several factors. First, oxidative attack of the metal can produce corrosion deposits, or tubercles, that may partially block a pipe. Second, depletion of biocide or other chemicals used to treat the water in the system in an attempt to control corrosion in the system due to the presence of tuberculation, organic matter, and microbiological organisms associated therewith may result in microbiological growth. And third, leaks can result from general corrosion and/or microbiologically influenced corrosion, such as oxidation by trapped air. These factors may operate together to severely compromise the performance of the system.

Microbiological influenced or induced corrosion (MIC) can result when waterborne or airborne microbiological organisms, such as bacteria, molds, and fungi, are brought into the piping network of the protection system with untreated water and feed on nutrients within the piping system. These organisms establish colonies in the stagnant water within the system. Over time, the biological activities of these organisms cause significant problems within the piping network. Both ferrous metal and cuprous metal pipes may suffer pitting corrosion leading to pin-hole leaks. Iron oxidizing bacteria form tubercles, which can grow to occlude the pipes. Tubercles may also break free from the pipe wall and accumulate in particularly sensitives areas, such as in or near heat exchangers. Even stainless steel is not immune to the adverse effects of MIC, as certain sulfate-reducing bacteria are known to be responsible for rapid pitting and through-wall penetration of stainless steel pipes.

In addition to MIC, other forms of corrosion are also of concern. For example, the presence of water and oxygen within the piping network can lead to oxidative corrosion of ferrous materials. Such corrosion can cause leaks as well as foul the network with iron oxide particles (e.g., rust particles) in the form of hematite (Fe2O3) or magnetite (Fe3O4), deteriorating the system hydraulics. Presence of water in the piping network having a high mineral content can also cause mineral scale deposition, as various dissolved minerals, such as calcium, magnesium, and zinc, react with the water and the pipes to form mineral deposits on the inside walls. In the presence of dissolved oxygen, these deposits can act to accelerate corrosion of the pipe just beneath the deposits. These deposits can inhibit water flow.

A need, therefore, exists in building mechanical systems that may include water-based fire protection systems and/or closed loop water chiller systems for methods that reduce corrosion within the pipe network of the systems and resulting deterioration of system performance.

### SUMMARY

An aspect of the present disclosure is to provide a building pipe network inerting system configured to inert various building pipe networks with an inert gas and method of operating such a supply system and the associated building pipe networks. An inert gas source, such as nitrogen gas source is connected with the pipe network. Inert gas is supplied from the inert gas source to the pipe network. In certain aspects, the inert gas is supplied to the inert gas while the pipe network is filled with water. In another aspect, the inert gas is supplied to the pipe network while the pipe network is being drained of water. In yet another aspect, the inert gas is supplied to the pipe network while the pipe network is being filled with water. The inert gas may also be supplied to the pipe network while the pipe network is empty, for example, when it is not filled with water and/or atmospheric air.

Filling the pipe network with the inert gas and/or water substantially fills the pipe network, thereby compressing the inert gas within the pipe network. In another aspect, at least some of the compressed gas may be vented from the pipe network. The compressed gas may be vented under particular circumstances, such as air pressure being above a particular pressure level, or for a particular time duration, or the like. Oxygen rich air may be removed from the pipe network during operation or prevented from entering the pipe network when draining water from the pipe network or filling the pipe network with water.

Gas may be discharged from the pipe network after supplying inert gas and prior to filling the system with water. The supplying and discharging of inert gas from the inert gas source to the pipe network may be repeated before supplying water to the pipe network, thereby increasing concentration of inert gas in the pipe network or during draining of water from the pipe network to minimize oxygen from entering the pipe network. The discharging of gas from the pipe network may include opening a drain valve in the pipe network.

In another aspect, a venting assembly may be provided that is operable to vent air under particular circumstances, such as air pressure being above a particular pressure level. The pressure level may be fixed or adjustable. A gauge may be provided for setting an adjustable pressure level. The venting assembly may include an air vent and an airflow regulator. The air vent is connected with the pipe network and discharges to the airflow regulator. In another aspect, the air vent may further include a redundant air vent, with the air vent discharging to the airflow regulator through the redundant air vent. The airflow regulator may be in the form of a pressure relief valve, a back-pressure regulator, or a check valve. A sampling port may be provided for sampling air that is discharged from the airflow regulator.

These aspects are merely illustrative of the innumerable aspects associated with the present disclosure and should not be deemed as limiting in any manner. These and other aspects, features and advantages of the present disclosure will become apparent from the following detailed description when taken in conjunction with the referenced drawings.

### DESCRIPTION OF DRAWINGS

Reference is now made more particularly to the drawings, which illustrate the best presently known mode of carrying out the disclosure and wherein similar reference characters indicate the same parts throughout the views.

FIG. 1 is a schematic drawing of a first exemplary closed loop water chiller system.

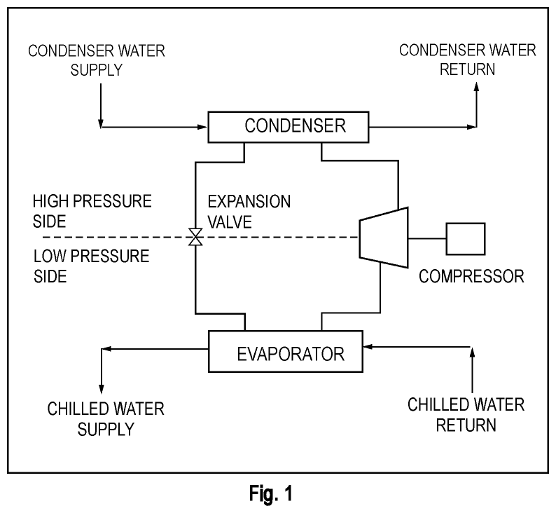

FIG. 2 is a schematic drawing of a second exemplary closed loop water chiller system.

FIG. 3 is a schematic drawing of a first embodiment of a closed loop water chiller system incorporating an inert gas source as described herein.

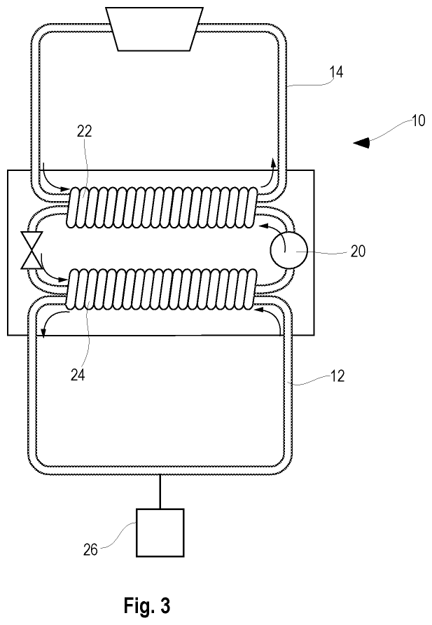

FIG. 4 is a schematic drawing of another embodiment of a closed loop water chiller system incorporating an inert gas source and vent as described herein.

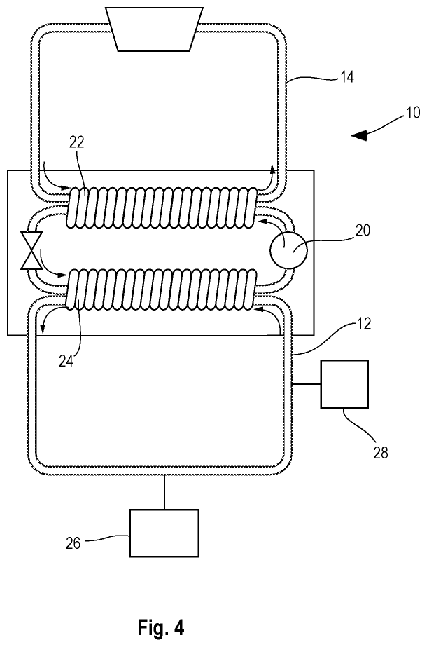

FIG. 5 is a schematic drawing of a yet another embodiment of a closed loop water chiller system incorporating an inert gas source, vent and inline corrosion detector as described herein.

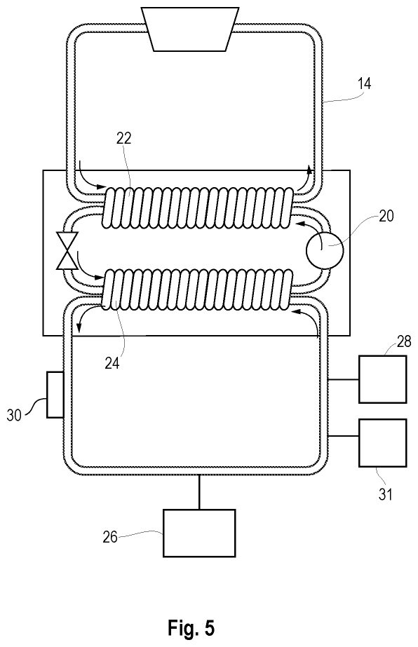

FIG. 6 is a flow diagram of an inerting process for a closed loop water chiller system and/or a wet pipe fire protection system.

FIG. 7 is a flow diagram of a drain and refill process for a closed loop water chiller system and/or a wet pipe fire protection system.

FIG. 8 is a schematic illustration of a first embodiment of a building nitrogen supply system.

FIG. 9 is a schematic illustration of a second embodiment of a building nitrogen supply system.

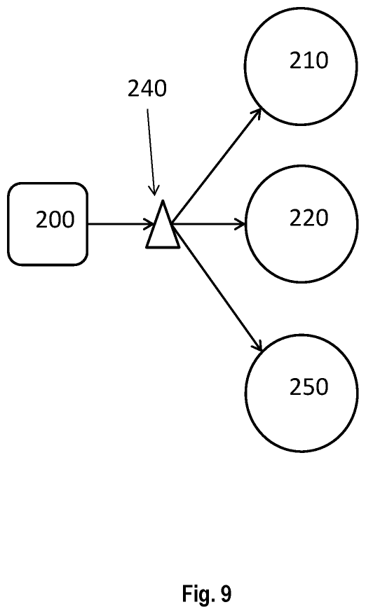

FIG. 10 is a plan view of an improved quick-connect assembly.

FIG. 11 is a front elevation of an exemplary venting assembly suitable for use in embodiments of the present disclosure.

FIG. 12 is a schematic diagram of an exemplary pipe network that may comprise a portion of the building system in embodiments of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure, and are not intended to limit the disclosure of the technology or any aspect thereof In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

The present technology includes closed loop water chiller systems and methods of reducing corrosion in closed loop water chiller systems. A closed loop water chiller system includes a pipe network, a compressor, a condenser, an evaporator, and an inert gas source connected with the pipe network. The inert gas source may be a nitrogen generator. The nitrogen generator may be a nitrogen membrane system or a nitrogen pressure swing adsorption system. The present systems and methods reduce or nearly eliminate corrosion that typically affects conventional closed loop water chiller systems, which can deteriorate or even compromise function.

Corrosion in the chiller system is reduced by displacing oxygen within the system using an inert gas that does not react with the pipe material, for example, nitrogen, from the inert gas source. Displacing oxygen with nitrogen includes filling the piping network of the sprinkler system with pressurized inert gas source from the inert gas source. The pressurized inert gas thereby displaces air, which contains about 21% oxygen, out of the piping. Displacing oxygen with inert gas can also include filling the piping network with water and providing inert gas into the water as it fills or is contained in the piping network. The inert gas added to the water thereby forces dissolved oxygen out of the water into the gas phase which can be vented out of the system through vents that are specifically designed to remove the trapped gasses from the system. A further description of the process of utilizing inert gas to remove oxygen from a pipe network is provided in U.S. Pat. No. 9,144,700, issued Sep. 29, 2015, U.S. Pat. No. 9,186,533, and U.S. Published Patent Application 2015/0014000, published Jan. 15, 2015, now U.S. Pat. No. 10,188,885, the entire disclosures of each of which are hereby incorporated by reference.

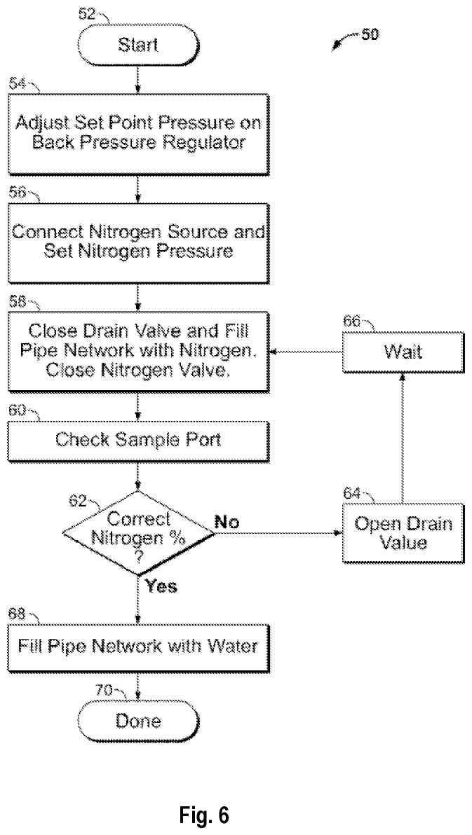

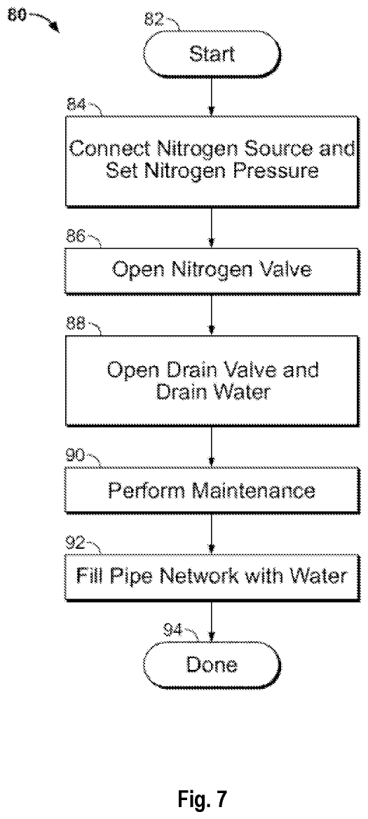

Inerting and drain and refill processes for water chiller and fire protection systems (or similar closed loop water based systems) that may be accomplished with the present disclosure operate as follows and, for example, according to the flow charts provided in FIGS. 6 and 7. When system is initially set up or undergoes extensive maintenance, an inerting process 50 is carried out with nitrogen or other inert gas (FIG. 6). Process 50 starts 52 by a technician setting 54 the set point pressure on a back-pressure regulator. Nitrogen source is connected with pipe network, and nitrogen pressure of an air maintenance device is set 56. Typically, the nitrogen pressure is set below the set point pressure of the back-pressure regulator to prevent the back-pressure regulator from opening during the inerting process 50. For example, nitrogen pressure may be set to approximately 30 PSIG and set point pressure of back-pressure regulator set to approximately 50 PSIG. Drain valve is closed and nitrogen valve opens to fill pipe network with nitrogen rich air 58. Nitrogen valve is then closed to prevent additional gas injection. The technician may then sample the relative concentration of oxygen and nitrogen at sample port by opening port and allowing air to flow through tube for a sufficient time, such as several minutes, to allow levels to stabilize 60. A manual or automatic oxygen meter can then be connected to port to achieve continuous or intermittent oxygen readings. Nitrogen concentration may be inferred at 60 by subtracting the oxygen concentration percentage from 100%.

It is then determined if the nitrogen concentration is at a desired level 62. If it is not, drain valve is opened 64. After a delay 66 to allow pressure in pipe network to drop to atmospheric pressure, the drain valve is again closed and steps 58 through 62 repeated until it is determined at 62 that the concentration of nitrogen in the pipe network is high enough. It should be understood that steps 60 and 62 are optional and may be eliminated once process 50 has been performed one or more times. Once it is determined at 62 that the nitrogen concentration is sufficient, source valve is then opened 68 to admit water to the pipe network. The relatively high pressure of the water, such as between approximately 76 PSIG and 150 PSIG, compresses the nitrogen rich air in pipe network to a fraction of its volume and raises the pressure of the air above the set point of back-pressure regulator. This causes back-pressure regulator 36 to discharge the nitrogen rich air until essentially all of the air is depleted from the system at which time air vent closes in the presence of water. Back-pressure regulator then closes to prevent high oxygen rich air from entering the pipe network when it is subsequently drained of water.

Once inerting process 50 is carried out, system may be able to be drained and refilled using a drain and refill process 80 without the need to repeat inerting process 50. Drain and refill process 80 begins 82 with system filled with water either using inerting process 50 or by a conventional process. The nitrogen pressure is adjusted 84, such as by adjusting the air maintenance device. Nitrogen valve is opened 86 in order to allow nitrogen gas to flow into the pipe network. Drain valve is opened 88 to drain water from the pipe network. When the pressure in the pipe network falls below the nitrogen pressure, nitrogen gas will enter the pipe network to resist high oxygen rich air from entering the pipe network through drain valve in response to a vacuum that occurs as the piping network is emptied of water. The airflow regulator of venting assembly will prevent a substantial amount of oxygen rich air from entering through air vent 34. Once any maintenance is performed at 90 the pipe network can be refilled with water at 92. Any air in pipe network will be discharged through venting assembly in the manner previously described.

By varying the purity of the source of nitrogen gas, the fill pressure and the number of times that steps 58 through 62 are repeated, the concentration of nitrogen can be established at a desired level. For example, by choosing a nitrogen source of concentration between 98% and 99.9% and by filling and purging the piping network at approximately 50 PSIG for four (4) cycles, a concentration of nitrogen of between 97.8% and 99.7% can be theoretically achieved in system. A fewer number of cycles will result in a lower concentration of nitrogen and vice versa.

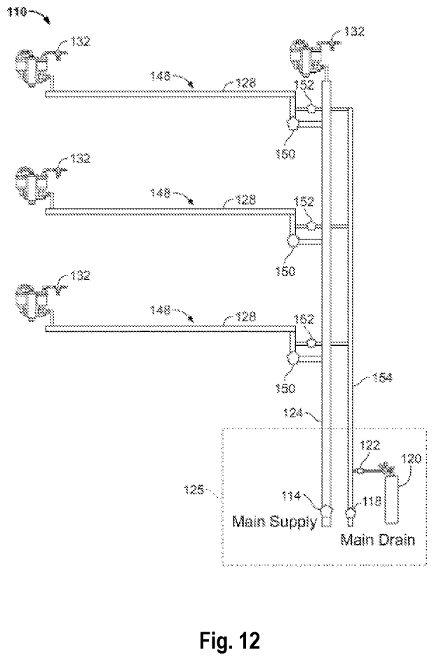

An exemplary pipe network, in this case a fire protection system pipe network is illustrated in FIG. 12. While a fire protection system pipe network is illustrated, the same principles apply to the pipe network of a closed loop water chiller system as well. The filling of a pipe network 112 with water either during or after it is filled with high nitrogen air tends to reduce corrosion in pipe network 112. This is because most air is removed from the pipe network and the amount that remains is low in oxygen. It is further believed that only a small amount of oxygen is supplied with the water. Because corrosion is believed to begin primarily at the water/air interface and little oxygen is present in the high nitrogen environment, corrosion formation is inhibited.

Moreover, a high nitrogen, or other inert gas, pipe network system may be provided in certain embodiments without the need to apply a vacuum to the system after draining in order to remove high oxygen air. This reduces the amount of time required to place the system back into operation after being taken down for maintenance. Maximum time of restoration is often dictated by code requirements and may be very short. Also, the elimination of a vacuum on the system avoids potential damage to valve seals, and the like, which allows a greater variety of components to be used in the pipe network.

An exemplary pipe network system 110, in this case, a fire protection system, includes a pipe network 112, a source of water for the pipe network, such as a supply valve 114, in some networks a drain valve 118 for draining the pipe network and a source of inert gas, such as a nitrogen source 120 connected with the pipe network. Nitrogen source 120 may include any type of nitrogen generator known in the art, such as a nitrogen membrane system, nitrogen pressure swing adsorption system, or the like. Such nitrogen generators are commercially available from Holtec Gas Systems, Chesterfield, Mo. Alternatively, nitrogen source 120 may be in the form of a cylinder of compressed nitrogen gas. Because such nitrogen cylinders are compressed to high pressures, an air maintenance device 121 may be provided to restrict flow and/or pressure supplied to pipe network 112 in order to prevent over-pressurization of the network. Alternatively, nitrogen source 120 may be a connection to a nitrogen system if one is used in the facility in which system 110 is located. Alternatively, nitrogen source 120 may be a transportable nitrogen generator of the type disclosed in commonly assigned U.S. patent application Ser. No. 61/383,546, filed Sep. 16, 2010, by Kochelek et al., the disclosure of which is hereby incorporated herein by reference.

The pipe network 112 further includes a venting assembly 132 for selectively venting air from pipe network 112. In the illustrative embodiment, venting assembly 132 vents air and not water from the pipe network in order to remove at least some of the air from the pipe network when the pipe network is filled with water in the manner described in U.S. patent application Ser. No. 12/615,738, filed on Nov. 10, 2009, entitled AUTOMATIC AIR VENT FOR FIRE SUPPRESSION WET PIPE SYSTEM AND METHOD OF VENTING A FIRE SUPPRESSION WET PIPE SYSTEM, the disclosure of which is hereby incorporated herein by reference. Venting assembly 132 further prevents substantial air from entering pipe network 112 when the pipe network is drained of water as described herein. This avoids oxygen rich air from entering the pipe network at venting assembly 132 in response to a relative vacuum drawn on pipe network 112 by the draining of water, thereby displacing high nitrogen air in the pipe network. Venting assembly 132 may further be configured to vent air from the pipe network only under particular circumstances, such as air pressure in the pipe network being above a particular set point pressure level, thereby facilitating an inerting process, as described herein, which may be carried out below the set point pressure level of the venting assembly. However, the venting may be based on other circumstances, such as based upon timing using a time-operated valve.

Pipe network 112 may a generally vertical riser 124 to which drain valve 118 and supply valve 114 are connected and one or more generally horizontal mains 126 extending from riser 124. Pipe network 112 may further include a plurality of generally horizontal branch lines 128 connected with main 126, either above the main, such as through a riser nipple 130 or laterally from the side of the main. Sprinkler heads 116 extend from a branch line 128 via a drop 129. A pipe network for a closed loop water chiller or other networks may not include a riser, mains or branch lines or other network features specific to fire protection systems. Further, these other pipe networks may not include a vent or venting assembly as described herein. Alternately, the networks may be provided with a vent or venting assembly that may be positively locked in a closed position during regular operation of the pipe network.

In the illustrated embodiment, venting assembly 132 is connected with pipe network 112 at main 126 distally from the portion of the main that is connected with riser 124. This ensures that the main is vented. However, venting assembly 132 could be connected with a branch line 128. The venting assembly does not always need to be the highest point in pipe network 112.

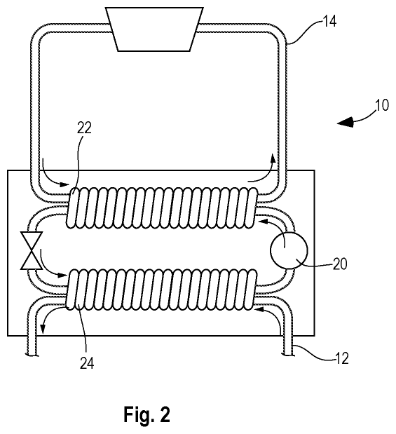

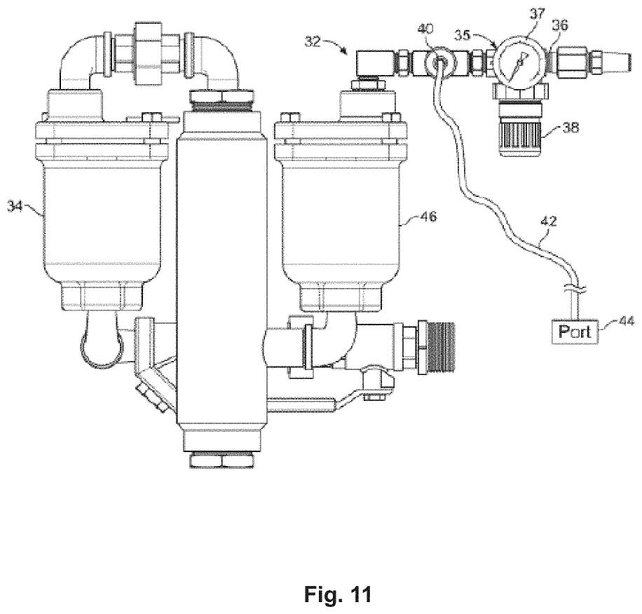

In the illustrated embodiment, venting assembly 132 is made up of an air vent 134 and an airflow regulator 135 (FIG. 11). Air vent 134 is connected with the pipe network 112 and discharges to airflow regulator 135. In embodiment illustrated in FIG. 2, airflow regulator 135 is in the form of a back-pressure regulator 136. Back-pressure regulator 136 responds to the pressure in the pipe network 112 by discharging air through air vent 134 that is above a set point pressure of the back-pressure regulator. In order to assist in field-setting the set point pressure, back-pressure regulator 136 includes a pressure gauge 137 that displays the pressure supplied to the back-pressure regulator and an adjustment knob 138 that allows the set point to be adjusted. In addition, a sample port 140 may be provided at back-pressure regulator 136 to allow the relative oxygen concentration (and, therefore, the nitrogen concentration) to be measured. Sample port 140 may be connected with a narrow gauge metal or plastic tube 142 to a port 144 at a more accessible location. Thus, by connecting an oxygen meter to port 144 at ground level, a technician can measure the relative oxygen/nitrogen makeup of the air being discharged to determine if additional fill and purge cycles are necessary to adequately inert the pipe network.

Venting assembly 132 may further include a redundant air vent 146 that provides redundant operation in case of failure of primary air vent 134. Such redundancy avoids water from being discharged to back-pressure regulator 136 and to the environment upon failure of the primary air vent where it may cause damage before the failure is discovered. Such redundant air vent is as disclosed in U.S. patent application Ser. No. 12/615,738, filed on Nov. 10, 2009, entitled AUTOMATIC AIR VENT FOR FIRE SUPPRESSION WET PIPE SYSTEM AND METHOD OF VENTING A FIRE SUPPRESSION WET PIPE SYSTEM, the disclosure of which is hereby incorporated herein by reference. In particular, primary air vent 134 discharges to redundant air valve 146 which, in turn, discharges to back pressure regulator 136.

Venting assemblies, including manually operated, electrically operated, and redundant vents, and methods of venting piping networks, suitable for use in pipe networks as described herein are further described in U.S. Pat. No. 8,636,023, issued Jan. 28, 2014, U.S. Pat. No. 9,717,935, issued Aug. 1, 2017, and U.S. Pat. No. 9,884,216, issued Feb. 6, 2018, the entire disclosures of each of which are hereby expressly incorporated by reference

Alternatively, airflow regulator 135 can be made up of a pressure relief valve. A pressure relief valve functions in a similar manner to a back-pressure regulator, except that its set point is fixed at the factory and cannot be field adjusted. Alternatively, the airflow regulator can be in the form of a check valve which allows air to be discharged from air vent 134 to atmosphere, but prevents high oxygen content atmospheric air from being drawn through air vent 134 to the pipe network when it is drained of water. Back-pressure regulator 136 and the alternative pressure relief valve are commercially available from multiple sources, such as Norgren Company of Littleton, Colo., USA.

Airflow regulator 135 operates by allowing air vented by air vent 134 to be discharged to atmosphere. However, airflow regulator 135 prevents atmospheric air, which is oxygen rich, from flowing through air vent 134 into pipe network 112, such as when it is being drained. In the illustrated embodiment in which airflow regulator 135 is made up of a back-pressure regulator or a pressure relief valve, airflow regulator 135 functions by opening above a set point pressure and closing below that set point pressure. Air vent 134 functions by opening in the presence of air alone (or other gaseous mixture) and closing in the presence of water. In this embodiment, venting assembly 132 will be open to vent gas from main 126 during filling of the fire sprinkler system with water which raises the pressure of the gas in pipe network 112 above the set point of the back-pressure regulator. Once substantially all of the gas is vented, the presence of water at air vent 134 will close the air vent resulting in closing of the back-pressure regulator. Then, when the fire sprinkler system is being emptied of water, the air pressure within main 126 will decrease as a result of water being drained, as would be understood by the skilled artisan, thereby maintaining airflow regulator 135 closed to prevent drawing in a substantial amount of high oxygen content atmospheric air. This will prevent substantial amounts of oxygen rich atmospheric air from entering pipe network 112 during draining.

In some cases, the chiller system further includes a vent positioned within the piping network. The vent allows gas such as air and oxygen that is displaced by pressurized inert gas or the pressurized inert gas itself to exit the piping network. The chiller system may be drained of water at various times for maintenance or other reasons. During draining, inert gas may be supplied to the piping network in order to minimize or eliminate air and oxygen from reentering the piping network. Thereafter, oxygen is again displaced with inert gas by filling the piping network with pressurized inert gas and/or filling the piping network with water and providing inert gas into the water as it fills and/or while it is contained in the piping network.

In another advantageous implementation of the systems and methods herein, inline corrosion monitoring systems and methods may be employed. In one form, the inline corrosion monitoring system and method may incorporate at least metal coupon and an oxygen depletion area defined on a surface portion of the metal coupon as disclosed in U.S. Pat. No. 8,893,813, issued Nov. 25, 2014, the entire disclosure of which is expressly incorporated by reference herein. A mounting member positions the corrosion monitor assembly to be at least partially covered with water when the chiller system is in operation. The oxygen depletion area may be defined by a non-metal material abutting the surface portion of the coupon. The non-metal material may be a polymeric material, such as polytetrafluoroethylene (PTFE). The corrosion monitor assembly may include another metal coupon and another oxygen depletion area defined on a surface portion of the other coupon. The oxygen depletion area on the surface portion of the other coupon may be defined by a non-metal material abutting said surface portion of the other coupon. Opposite sides of a common non-metal material may abut the surface portions of the coupon and the other coupon. The coupon and the other coupon may be made from metals that are the same or from different metals. The metals may be chosen from galvanized steel, copper, brass, austenitic steel and mild steel. The mounting member preferably positions the corrosion monitor assembly to extend across at least half of a diameter of the pip network.

U.S. Pat. No. 9,095,736, issued Aug. 4, 2015, the entire disclosure of which is hereby incorporated by reference herein, describes another suitable form of inline corrosion monitoring device and method. In a first application, a piping network of a chiller system includes a pipe having a first pipe portion and a second pipe portion. The first pipe portion includes a wall having a first wall thickness, and the second pipe portion includes a wall having a second wall thickness that is greater than the first wall thickness. The fire sprinkler system further includes structure coupled to the pipe and defining a sealed chamber between the structure and the first pipe portion, and a sensor for sensing a pressure in the sealed chamber.

In another application, a corrosion monitoring device includes a pipe having opposite ends and a middle portion positioned between the opposite ends. The opposite ends of the pipe each include a wall having a first wall thickness, and the middle portion of the pipe includes a wall having a second wall thickness that is less than the first wall thickness. The corrosion monitoring device further includes structure coupled to the pipe and defining a sealed chamber between the structure and the pipe, and a sensor for sensing a pressure in the sealed chamber.

In another application, a method of installing a corrosion monitoring device in a chiller system includes removing a section of the pipe from the piping network of a chiller system to create two pipe ends with a space between, positioning the corrosion monitoring device in the space, and coupling the corrosion monitoring device to the two pipe ends.

In another application, a chiller system includes a pipe having a first pipe portion and a second pipe portion. The first pipe portion includes a wall having a first wall thickness, and the second pipe portion includes a wall having a second wall thickness. The fire sprinkler system also includes structure coupled to the pipe and defining a sealed chamber between the structure and the first pipe portion, and a sensor for sensing a parameter associated with the sealed chamber.

In another application, a corrosion monitoring device for a chiller system includes a pipe having opposite ends and a middle portion positioned between the opposite ends. The opposite ends of the pipe each include a wall having a first wall thickness, and the middle portion of the pipe includes a wall having a second wall thickness. The corrosion monitoring device further includes structure coupled to the pipe and defining a sealed chamber between the structure and the first pipe portion, and a sensor for sensing a parameter associated with the sealed chamber.

In another application, a method of monitoring corrosion within a chiller system having a pipe, and structure coupled to the pipe and defining a sealed chamber between the structure and the pipe, is disclosed. The method includes sensing, with a pressure sensor, a pressure within the sealed chamber. The method also includes detecting a change in pressure within the sealed chamber, corresponding to a breach of a pipe wall of the sealed chamber. The method further includes generating a signal in response to detecting the change in pressure within the sealed chamber.

In another application, a method of monitoring corrosion within a chiller system having a pipe, and structure coupled to the pipe and defining a sealed chamber between the structure and the pipe, is disclosed. The method includes sensing a parameter associated with the sealed chamber, and detecting a change in the parameter associated with the sealed chamber, corresponding to a breach of a pipe wall of the sealed chamber. The method also includes generating a signal in response to detecting the change in the parameter associated with the sealed chamber.

Yet another suitable inline corrosion monitor device and method suitable for use in a closed loop water chiller system is described in U.S. Pat. No. 9,839,802, issued Dec. 12, 2017, the entire disclosure of which is hereby incorporated by reference herein.

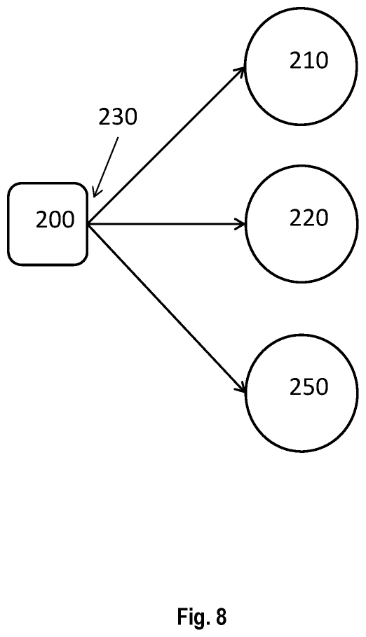

It is contemplated within the scope of this disclosure that the foregoing systems may be incorporated into a total building nitrogen system. FIG. 8 schematically illustrates an example of such a system. At the heart of such a system is a nitrogen source 200. The nitrogen source 200 may be either a nitrogen (or other inert gas) generator—with or without an air compressor—storage tank, or other source that provides a consistent and constant supply of nitrogen or other inert gas. The nitrogen source 200 should be sized to contain or generate a sufficient flow of nitrogen at least to simultaneously satisfy each of the operations described below and, in more critical applications where a supply interruption may result in significant harm or damage, further including a supply “cushion” in excess of that calculated need in order to account for unforeseeable spikes in demand. In alternate embodiments, the nitrogen source 200 may include a combination of multiple generators and/or storage tanks. A selector mechanism may be connected between these multiple generators and/or storage tanks and any gas delivery pipe network to allow selection of one or more of the multiple generators and/or storage tanks, for example, depending on the demand load of the gas delivery network at a given point in time.

The nitrogen source 200 is connected with any closed loop water chiller systems 210 in the manners described above. However, the nitrogen source 200 may also serve the additional functions of inerting any fire protection system 220 in service in the building, as described in the '700, '533, and/or '885 patents discussed and incorporated by reference herein. Further, the system may serve to supply multiple chiller systems and/or fire protection systems within a building or even a building complex. The nitrogen source 200 may have separate, dedicated connections to each of these systems 210, 220. Alternatively, the nitrogen source 200 may have a single output 230 that is routed to each system 210 and 220 through a selector valve 240 that allows building management to more specifically direct the flow of nitrogen to the various systems desired to be supplied by the nitrogen source 200. The selector valve 240 may be electronic or mechanical, and it may be locally controlled at the selector or remotely operable from a building, complex or plant control room or station. The selector valve 240 may direct the flow of nitrogen from the nitrogen source 200 to one or multiple systems.

In another embodiment of a building nitrogen system, a building (or plant or complex) nitrogen supply pipe network 250 may also be incorporated into the system. The nitrogen supply pipe network 250 delivers nitrogen to multiple connection locations within the building (or plant or complex) for use in any desired processes or other uses. In one advantageous embodiment, each connection location associated with the nitrogen supply pipe network 250 is provided with a quick connect/disconnect connection to facilitate connection of equipment to the nitrogen supply pipe network 250. A number of quick connect formats may be utilized, including, for example, industrial, automotive, or ARO type interchanges, pipe unions, or other such connections. In addition, sliding collar couplings, such as a ball-lock, roller-lock, pin lock, flat face, bayonet, ring-lock, or cam-lock couplings may be used. Electric, mechanical, manual, automatic, or remotely controlled shut-off valves may also be incorporated into these connections to provide further flow control options at the connection point.

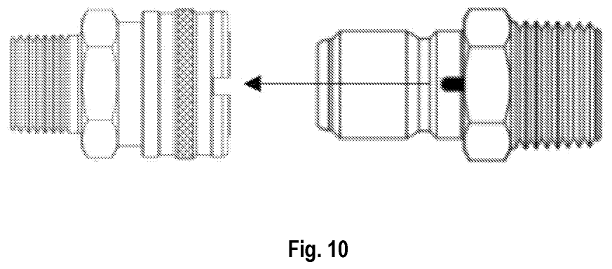

An alternative quick-connect arrangement is illustrated in FIG. 10. This quick-connect 300 consists of a male portion or plug 310 and a female portion or socket 320. The male plug half 310 includes a hollow core (“straight-through”) design that reduces the amount of resistance to flow through the quick-connect 300. The male plug 310 also incorporates an interlocking alignment pin 330 mounted on or in a surface of a hex-head flange facing in a direction parallel to the core axis of the plug 310. The alignment pin 330 is press-fit metal dowel or similar structure in one embodiment. In a preferred embodiment, the alignment pin 330 includes a chamfered top portion 340.

The female portion or socket 320 similarly includes a hollow core (“straight-through”) design that reduces the amount of resistance to flow through the quick-connect 300. In order to mate appropriately with embodiments of the plug 310 that incorporate an alignment pin 330, corresponding embodiments of the socket 320 are provided with a notch or cavity 350 having a diameter allowing for a sliding fit with the alignment pin 330. The chamfered top end 340 of the alignment pin 340 facilitates alignment and entry of the alignment pin 330 into the notch or cavity 350. The engagement of the alignment pin 340 and notch or cavity 350 ensures consistent alignment of the connected components as desired. The socket 320 may also be provided with an 0-ring seal contained within the socket to enhance sealing between the plug 310 and socket 320.

A number of securing mechanisms may be incorporated into the described quick-connect 300. In the illustrated embodiment, a sliding collar locking mechanism, for example, a ball-lock, roller-lock, pin lock, flat face, bayonet, ring-lock, cam-lock, or the like, is used. However, other mechanisms, such as a screw collar (not shown), may be used. In this latter case, the plug 310 and socket 320 would be provided with corresponding threads—on the exterior of the upper portion of the plug 310 and on the interior of the collar portion of the socket 320. In this type of embodiment, the alignment pin 330 and notch or cavity 350 would be located inside of the inner diameter of the screw collar.

The preferred embodiments of the disclosure have been described above to explain the principles of the invention and its practical application to thereby enable others skilled in the art to utilize the invention. However, as various modifications could be made in the constructions and methods herein described and illustrated without departing from the scope of the invention, it is intended that all matter contained in the foregoing description or shown in the accompanying drawings, including all materials expressly incorporated by reference herein, shall be interpreted as illustrative rather than limiting. Thus, the breadth and scope of the present invention should not be limited by the above-described exemplary embodiment, but should be defined only in accordance with the following claims appended hereto and their equivalents.

What is claimed is:

1. An inert gas-based building pipe network inerting system, comprising:
an inert gas source;
at least one of a closed loop water chiller system and a fire protection system;
the closed loop water chiller system further comprising:
a compressor;
a condenser;
an evaporator;
a first pipe network; and
a first vent in fluid communication with the first pipe network and configured to allow venting of gas from the first pipe network;
the fire protection system further comprising:
a source of pressurized water;
a second pipe network fluidly connected with the source of pressurized water;
a sprinkler fluidly connected with the second pipe network; and
a second vent in fluid communication with the second pipe network and configured to allow venting of gas from the second pipe network;
a first fluid connection between the first pipe network and the inert gas source; and
a second fluid connection between the second pipe network and the inert gas source.

2. A method of operating the inert gas-based building pipe network inerting system to protect the closed water chiller system and/or fire protection system set forth in claim 1, comprising the step of supplying an inert gas from the inert gas source into the first and/or second pipe network while the pipe network contains water.

3. A method of operating the inert gas-based building pipe network inerting system to protect the closed water chiller system and/or fire protection system set forth in claim 1 herein, comprising the step of supplying nitrogen from the nitrogen source into the first and/or second pipe network while the pipe network is filled with water.

4. A method of operating the inert gas-based building pipe network inerting system to protect the closed water chiller system and/or fire protection system set forth in claim 1, comprising the step of supplying nitrogen from the nitrogen source into the first and/or second pipe network while the pipe network is drained of water.

5. A method of operating the inert gas-based building pipe network inerting system to protect the closed water chiller system and/or fire protection system set forth in claim 1, comprising the steps of:
supplying an inert gas from the inert gas source into the first and/or second pipe network while the pipe network contains water; and
venting trapped air and oxygen and/or pressurized inert gas within the first and/or second pipe network through the vent.

6. A method of operating the inert gas-based building pipe network inerting system to protect the closed water chiller system and/or fire protection system set forth in claim 1, comprising the steps of:
supplying an inert gas from the inert gas source into the first and/or second pipe network while the pipe network is filled with water; and
venting trapped air and oxygen and/or pressurized inert gas within the pipe network through the vent.

7. A method of operating the inert gas-based building pipe network inerting system to protect the closed water chiller system and/or fire protection system set forth in claim 1, comprising the steps of:
supplying an inert gas from the inert gas source into the first and/or second pipe network while the pipe network is drained of water; and
preventing air and oxygen from entering the pipe network through the vent.

8. The inert gas-based building pipe network inerting system as set forth in claim 1, further comprising an in line corrosion detector in communication with at least one of the first and second pipe network.

9. The inert gas-based building pipe network inerting system as set forth in claim 1, further comprising a third pipe network configured for conducting a building supply of inert gas to various locations within the building and including at least one connection point for accessing the building supply of inert gas from the third pipe network.

10. The inert gas-based building pipe network inerting system as set forth in claim 1, further comprising a selector manifold between the inert gas source and the first and second pipe network and configured to selectively turn a flow of inert gas to each of the first and second pipe network on and off

11. A method of operating an inert gas-based building pipe network inerting system having at least one pipe network, a source of water for the pipe network, a venting assembly configured to vent gas from said pipe network, and an inert gas source connected with the pipe network, the method comprising:
supplying an inert gas from the inert gas source to the pipe network to increase a pressure in the pipe network above atmospheric pressure;
supplying water to the pipe network, thereby filling the pipe network with water and compressing the inert gas in the pipe network; and
discharging gas including the inert gas from the pipe network via the venting assembly while supplying water to the pipe network.

12. The method of operating an inert gas-based building pipe network inerting system as set forth in claim 11, wherein supplying inert gas from the inert gas source to the pipe network includes setting an inert gas pressure in the pipe network to 30 psig.

13. The method of operating an inert gas-based building pipe network inerting system as set forth in claim 11, further comprising draining water from the pipe network.

14. The method of operating an inert gas-based building pipe network inerting system as set forth in claim 13, wherein draining includes preventing atmospheric air from entering the pipe network.

15. The method of operating an inert gas-based building pipe network inerting system as set forth in claim 14, further comprising supplying inert gas from the inert gas source to the pipe network while draining water from the pipe network.

16. The method of operating an inert gas-based building pipe network inerting system as set forth in claim 1, wherein discharging includes venting gas from the pipe network when pressure in the pipe network is above a set point pressure level.

17. A method of operating an inert gas-based building pipe network inerting system having a pipe network, a source of water for the pipe network, and an inert gas source connected with the pipe network, the method comprising:
supplying inert gas from the inert gas source to the pipe network to increase a pressure in the pipe network above atmospheric pressure;
discharging gas from the pipe network after supplying inert gas to the pipe network;
supplying water to the pipe network after discharging gas from the pipe network, thereby filling the pipe network with water and compressing inert gas in the pipe network; and
venting compressed inert gas from the pipe network using a venting assembly configured to vent gas and not water from the pipe network while supplying water to the pipe network.

18. The method of operating an inert gas-based building pipe network inerting system as set forth in claim 17, further comprising repeating supplying inert gas and discharging gas from the pipe network prior to supplying water to the pipe network, thereby increasing concentration of inert gas in the pipe network.

19. The method of operating an inert gas-based building pipe network inerting system as set forth in claim 18, wherein repeating includes repeating supplying inert gas and discharging gas from the pipe network prior to supplying water to the pipe network, until the inert gas concentration in the pipe network is established at a specified level.

20. The method of operating an inert gas-based building pipe network inerting system as set forth in claim 19, wherein the desired inert gas concentration level includes an inert gas concentration of between 97.8% and 99.7%.

21. The method of operating an inert gas-based building pipe network inerting system as set forth in claim 18, wherein repeating includes supplying inert gas and discharging gas from the pipe network prior to supplying water to the pipe network for a total of fewer than four cycles.

22. The method of operating an inert gas-based building pipe network inerting system as set forth in claim 17, wherein supplying inert gas from the inert gas source to the pipe network includes setting an inert gas pressure in the pipe network to 30 psig.

23. The method of operating an inert gas-based building pipe network inerting system as set forth in claim 17, wherein discharging gas from the pipe network includes opening a valve coupled to the pipe network, thereby allowing gas to discharge from the pipe network.

24. The method of operating a nitrogen-based building inerting system as set forth in claim 17, wherein venting includes venting compressed nitrogen gas when pressure in the pipe network is above a set point pressure level.

25. The method of operating an inert gas-based building pipe network inerting system as set forth in claim 24, wherein the set point pressure level is 50 psig.

26. The method of operating an inert gas-based building pipe network inerting system as set forth in claim 17, further comprising draining water from the pipe network, wherein draining includes preventing atmospheric air from entering the pipe network.

27. The method of operating an inert gas-based building pipe network inerting system as set forth in claim 17, further comprising sampling gas discharged from the pipe network.

28. The method of operating an inert gas-based building pipe network inerting system as set forth in claim 17, further comprising:
draining water from the pipe network; and
supplying inert gas from the inert gas source to the pipe network while draining water from the pipe network, thereby preventing atmospheric air from entering the pipe network while the pipe network is being drained.

29. The method of operating an inert gas-based building pipe network inerting system as set forth in claim 28, further comprising refilling the pipe network with water after draining water from the pipe network, thereby filling the pipe network with water and compressing inert gas in the pipe network.
